(19) United States
(12) Patent Application Publication
(10) Pub. No.: US 2010/0279522 A1
(43) Pub. Date: Nov. 4, 2010

(54) CONNECTOR AND CIRCUIT BOARD HAVING THE SAME

(75) Inventor: Jane-How Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/765,868

(22) Filed: Apr. 23, 2010

(30) Foreign Application Priority Data
Apr. 29, 2009 (TW) 98114230

(51) Int. Cl. H01R 13/44; H01R 12/16

(52) U.S. Cl. 439/78; 439/136

(57) ABSTRACT

A connector and a circuit board having the same are disclosed. The circuit board includes a body, multiple electronic components and a connector. The electronic components are disposed on the body. The connector includes a base, a side wall, multiple terminals, a cover and a connecting element. The base is disposed on the body. The side wall is connected to the base and surrounds the base. The side wall and the base define a recess. The terminals pass through the base and are located in the recess, and are electrically connected to the body. The connecting element is connected between the side wall and the cover.

### CROSS-REFERENCE TO RELATED APPLICATION

This application claims the priority benefit of Taiwan application serial no. 98114230, filed on Apr. 29, 2009. The entirety of the above-mentioned patent application is hereby incorporated by reference herein and made a part of specification.

### BACKGROUND OF THE INVENTION

1. Field of the Invention

The invention relative to an electronic component and, more particularly, to a connector and a circuit board having the same.

2. Description of the Related Art

With the development of science and technology and the popularization of computer system, people get used to do their business, browse the internet, display audio/video files or store data with a computer. Today, computer becomes one of necessary tools in people's daily life.

Both a desktop computer and a notebook computer have circuit boards. On the circuit board, different electronic components are mounted to perform different functions. In addition, the circuit board has connectors for connecting peripherals including a keyboard, a mouse, a universal serial bus (USB) and the like. Some connectors are connected to connecting bases on a casing via transmission lines thereof, and the peripherals are connected to the connectors via the connecting bases. Detailedly speaking, the connector generally includes a base, a side wall and multiple terminals passing through the base and surrounded by the side wall. The terminals are electrically connected to the circuit board. However, the connector of such structure, which is usually called the head box connector, are directly exposed the terminals in ambient circumstance, and thus dust may accumulate on the terminals, or, the terminals may be hit and damaged by foreign objects.

### BRIEF SUMMARY OF THE INVENTION

The invention discloses a connector having cover connected to a base.

The invention discloses a circuit board including a body, multiple electronic components and at least a connector. The electronic components are disposed on the body. The connector includes a base, a side wall, multiple terminals, a cover and a connecting element. The base is disposed on the body. The side wall is connected to the base and surrounds the base. The side wall and the base define a recess. The terminals pass through the base and are secured to the base. One end of each terminal is located in the recess and the other end is electrically connected to the body. The connecting element is connected between the side wall and the cover.

In an embodiment of the invention, the side wall has a connecting portion connected to the connecting element. In addition, the connecting portion may be a hook, a post or a through hole.

In an embodiment of the invention, the cover has a connecting portion connected to the connecting element. In addition, the connecting portion may be a hook, a post or a through hole.

In an embodiment of the invention, the cover may be resilient, may be made of rubber, plastic or the like. With such, the cover is then easier to be squeezed somewhat into the recess and thereby securely mounted on the side wall.

In an embodiment of the invention, an identifying symbol is defined at a surface of the cover. In addition, the identifying symbol may be characters or a pattern, and the identifying symbol may include a first portion and a second portion with different colors. Furthermore, the identifying symbol may be a convex or a concave, and also may be a sticker.

Based on the above description, in the circuit board of the invention, the cover is connected to the base via the connecting element to prevent dust from accumulating on the terminals inside the connector. In addition, with the connecting element, there is no worry about storing the cover.

These and other features, aspects and advantages of the present invention will become better understood with regard to the following description, appended claims, and accompanying drawings.

### BRIEF DESCRIPTION OF THE DRAWINGS

FIG. 1A is a perspective view diagram showing the circuit board in a first embodiment of the invention.

FIG. 1B is a perspective view diagram showing the connector in FIG. 1A.

FIG. 2 is a cross sectional view diagram showing the connecting portion and the connecting element in FIG. 1B.

FIG. 3 is a cross sectional diagram showing the connecting portion and the connecting element in a second embodiment of the invention.

FIG. 4 is a cross sectional view diagram showing the connecting portion and the connecting element in a third embodiment of the invention.

FIG. 5 is a top view diagram showing the cover in FIG. 1.

FIG. 6 and FIG. 7 are top view diagrams showing the cover in the second and the third embodiments of the invention.

FIG. 8 is a side view diagram showing the cover in FIG. 5.

FIG. 9 is a side view diagram showing the cover in a fourth embodiment of the invention.

### DETAILED DESCRIPTION OF THE EMBODIMENTS

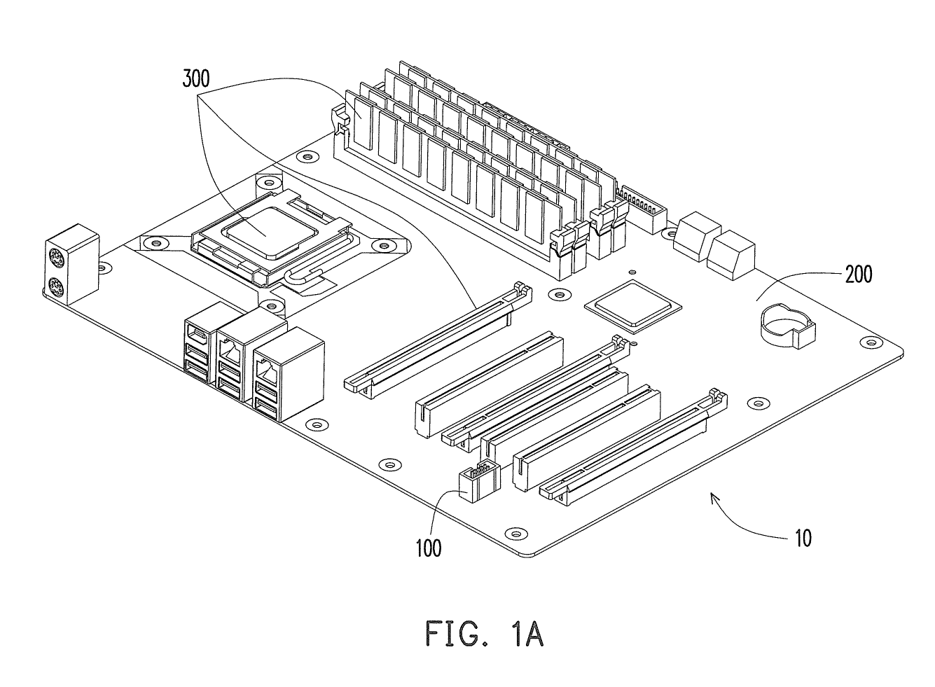

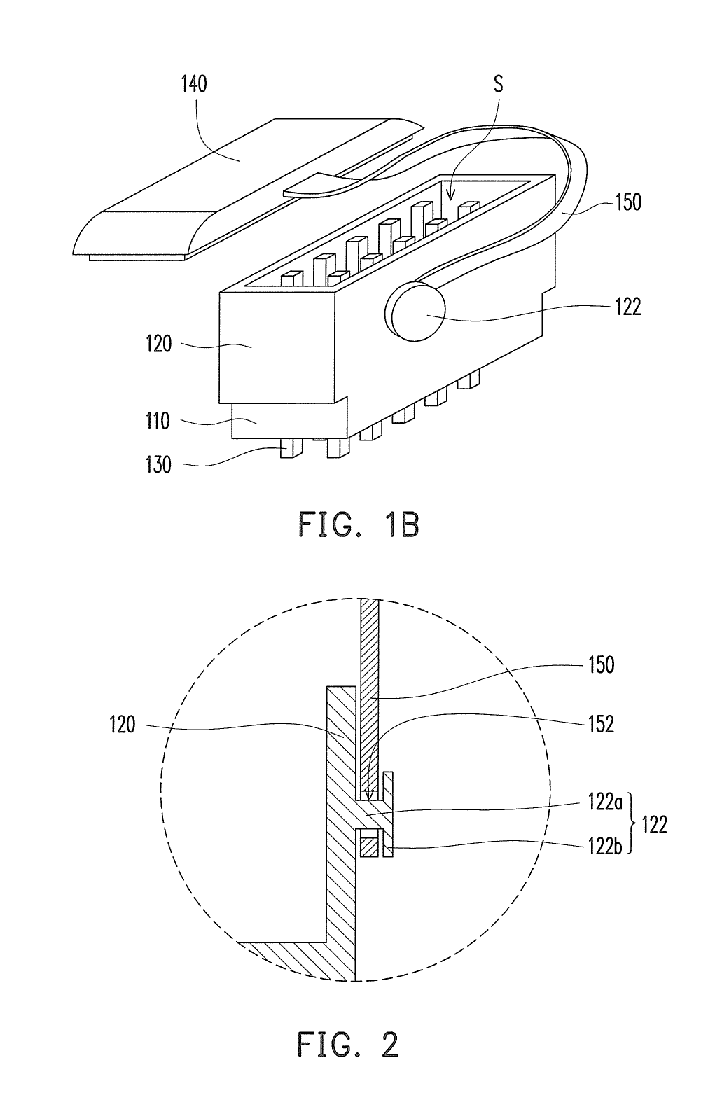

As shown in FIG. 1A and FIG. 1B, a circuit board 10 includes at least a connector 100, a body 200 and multiple electronic components 300. The connector 100 and the electronic components 300 are disposed on the body 200. The connector 100 includes a base 110, a side wall 120, multiple terminals 130, a cover 140 and a connecting element 150. The side wall 120 is connected to the base 110 and surrounds the base 110, and the base 110 and the side wall 120 define a recess S therebetween. The terminals 130 pass through the base 110 and are secured to the base 110. One end of each terminal 130 is electrically connected to the body 200, and the other end is located in the recess S. The cover 140 is preferably resilient, and may be made of plastic or rubber that is easy to be mounted on the connector 100 and cover the recess S. With such, the cover 140 is then easier to be squeezed somewhat into the recess S and thereby securely mounted on the side wall 120. The connecting element 150 is connected between the side wall 120 and the cover 140.

The electronic component 300 in the embodiment includes a central processing unit (CPU), a dynamic random access memory (DRAM), multiple interface card slots and other elements.

Detailedly, the side wall 120 has a connecting portion 122, and the connecting portion 122 and the connecting element 150 are connected to each other. In the embodiment, the connecting portion 122 is a post, and may be a hook, a through hole or other connecting portions. FIG. 2 is a cross sectional diagram showing the connecting portion and the connecting element in FIG. 1B. To make the relation of the connecting portion and the connecting element clear, some components are not shown in FIG. 2. As shown in FIG. 2A and FIG. 2B, the connecting portion 122 is a post, and the connecting portion 122 has a first portion 122a and a second portion 122b. The first portion 122a is connected to the side wall 120, and the second portion 122b is connected to the first portion 122a. The connecting element 150 has a hole 152, and the hole 152 is sleeved on the first portion 122a and interferes with the second portion 122b to fix the connecting element 150 to the connecting portion 122.

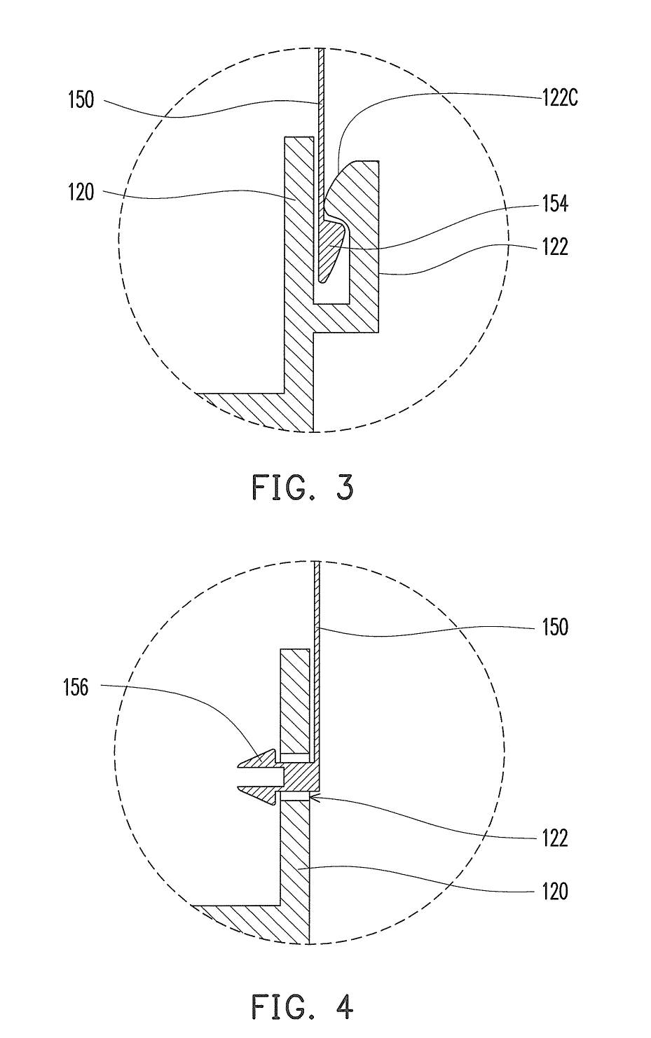

As shown in FIG. 3, the connecting portion 122 has a hook 122c, and the bottom of the connecting element 150 also has a hook 154. When the hook 154 enters the space between the side wall 120 and the connecting portion 122, it interferes with the hook 122c, and thus the connecting element 150 is fixed to the connecting portion 122.

As shown in FIG. 4, the connecting portion 122 is a through hole, and a tenon 156 is formed in a bottom of the connecting element 150. The tenon 156 engages the connecting portion 122 to fix the connecting element 150 to the side wall 120.

The connecting portion in the embodiment is not limited to a hook, a post or a through hole. Other mechanisms which can fix the connecting element 150 and the connecting portion 122 also may be used. In addition, in the embodiment, although a connecting portion 122 is disposed at the side wall 120, it is also may be disposed at the cover 140. That is, the cover 140 has a hook, a post, a through hole or mechanisms which may be fixed to the connecting element 150 to make the connecting element 150 connected between the side wall 120 and the cover 140. In present embodiment, the connecting element 150 and the cover 140 are integrally connected, however, the connecting element 150 and the side wall 120 may be integrally connected, or both the connecting element 150, the side wall 120, and the cover 140 be integrally connected.

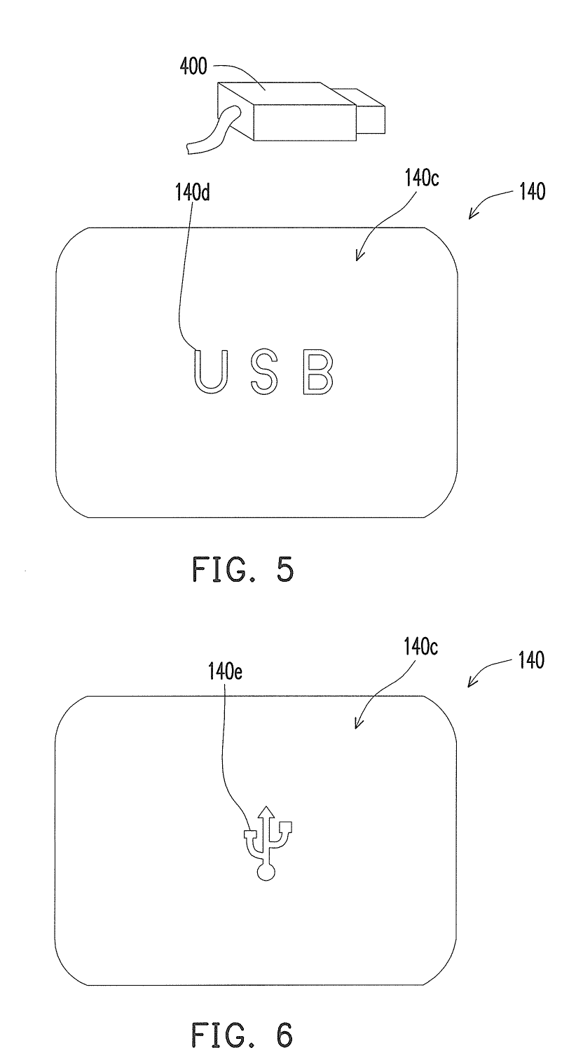

FIG. 5 is a top view diagram showing the cover in FIG. 1. As shown in FIG. 5, an identifying symbol 140d is defined on a surface 140c of the cover 140 to facilitate the user identifying the function of the connector 100 in FIG. 1A. In the embodiment, the identifying symbol 140d may be characters, and it indentifies that the connector 100 is adapted to an external connector 400. The external connector 400 is, for example, a USB connector.

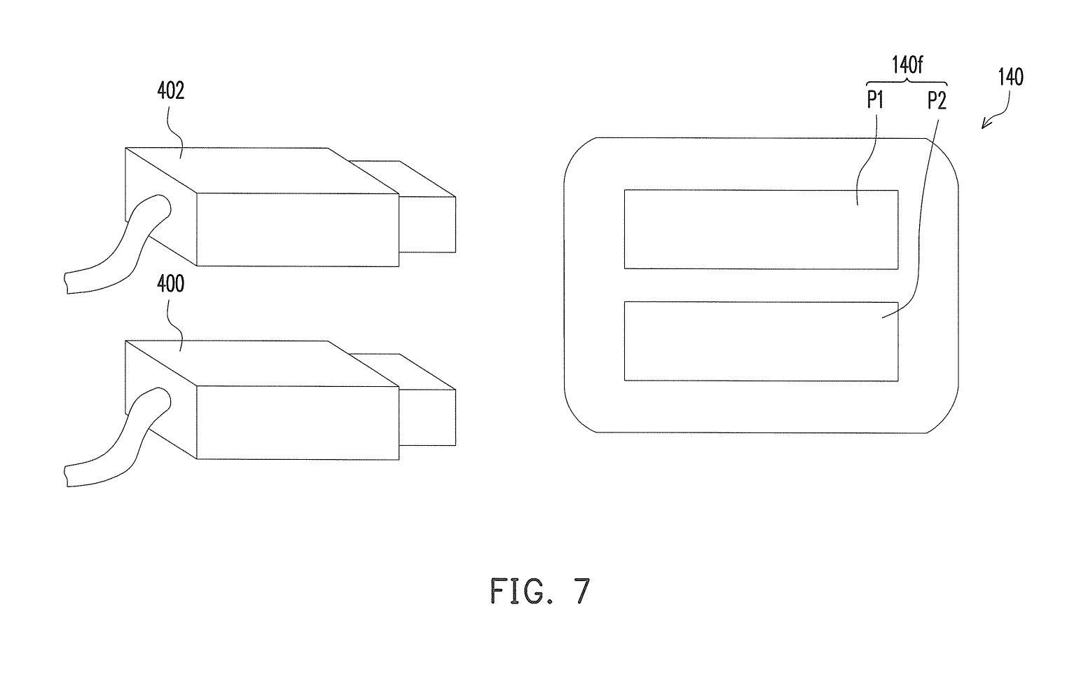

FIG. 6 is a top view diagram showing the cover in a second embodiment of the invention. As shown in FIG. 6, in the embodiment, an identifying symbol 140e on the cover 140 also may be a pattern with the identifying function, which is the same as the identifying symbol 140d in FIG. 5. FIG. 7 is a top view diagram showing the cover in a third embodiment of the invention. As shown in FIG. 7, in the embodiment, an identifying symbol 140f of the cover 140 has a first portion P1 and a second portion P2 with different colors to show that the terminals corresponding to the first portion P1 and the second portion P2 are adapted to an external connector 402 and an external connector 400, respectively. In other words, the connector in the invention may be connected to a single external connector (as shown in FIG. 5) or multiple external connectors (as shown in FIG. 7), and the identifying symbol 140f on the cover 140 may be adjusted correspondingly.

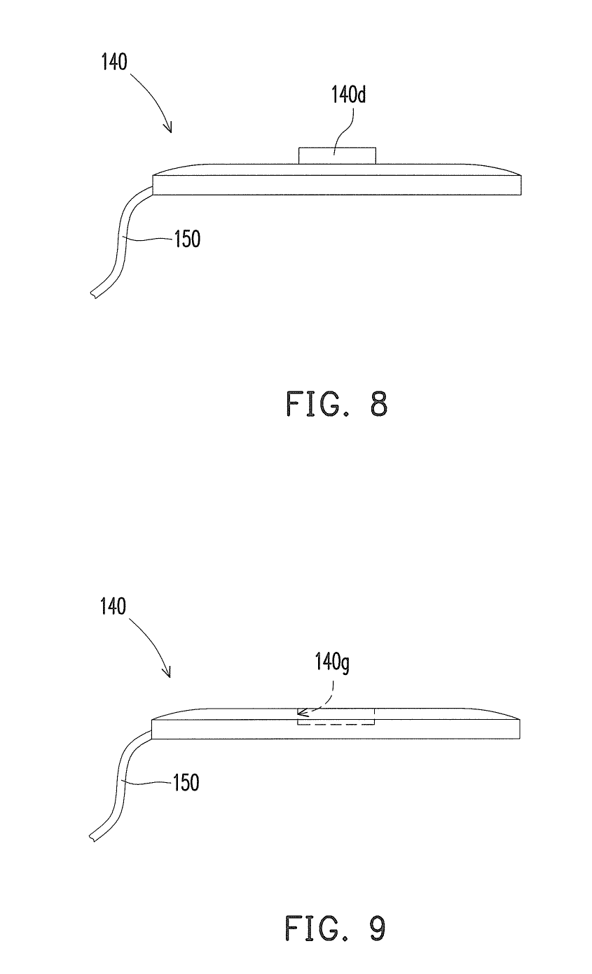

FIG. 8 is a side view diagram showing the cover in FIG. 5. In FIG. 8, the identifying symbol 140d may be a convex. FIG. 9 is a side view diagram showing the cover in a fourth embodiment of the invention. As shown in FIG. 9, compared with the convex in FIG. 8, an identifying symbol 140g also may be a concave. In addition, as shown in FIG. 7, the identifying symbol 140f also may be the sticker, and the first portion P1 and the second portion P2 may be two stickers with different colors.

In the embodiments above, the identifying symbol is defined at the cover to facilitate the user identifying the application of the connectors. In addition, the identifying symbol also may have different forms, FIG. 5 to FIG. 9 are just some examples, and other forms with the combination of symbols are also allowed. For example, a character sticker, a pattern sticker, a recessed pattern or a protrusion pattern are allowed.

To sum up, the invention discloses a connector and a circuit board having the same. The cover of the connector is connected to the base of the connector via the connecting element, which may prevent the terminal inside the connector form being smeared by dust or foreign body. Moreover, the cover does not need to be specially stored. In addition, an identifying symbol may be formed on the cover to show the type of the connector or the function of the terminals to guide the user to use the connector correctly.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A connector comprising:
a base;
a side wall connected to the base and surrounding the base, wherein the side wall and the base define a recess;
multiple terminals passing through the base and fixed to the base, wherein one end of each terminal is located in the connecting recess;
a cover; and
a connecting element connected between the side wall and the cover.

2. The connector according to claim 1, wherein the cover is resilient.

3. The connector according to claim 1, wherein the side wall has a connecting portion for fixing the connecting element.

4. The connector according to claim 1, wherein an identifying symbol is defined at a surface of the cover.

5. The connector according to claim 1, wherein the connecting element and the cover are integrally connected.

6. A circuit board having a connector, comprising:
a body;
multiple electronic components disposed on the body; and
at least a connector mounted on the body and including:
a base disposed on the body;
a side wall connected to the base and surrounding the base, wherein the side wall and the base define a recess;
multiple terminals passing through the base and fixed to the base, wherein one end of each terminal is located at the recess, and the terminals are electrically connected to the body;
a cover; and
a connecting element connected between the side wall and the cover.

7. The circuit board according to claim 6, wherein the side wall has a connecting portion for fixing the connecting element.

8. The circuit board according to claim 6, wherein an identifying symbol is defined at a surface of the cover.

9. The circuit board according to claim 6, wherein the connecting element and the cover are integrally connected.

10. The circuit board according to claim 6, wherein the cover is resilient.
